(19) United States
(12) Patent Application Publication
(10) Pub. No.: US 2024/0422528 A1
(43) Pub. Date: Dec. 19, 2024

(54) METHOD AND SYSTEM FOR CONFLICT MANAGEMENT IN WIRELESS COMMUNICATION SYSTEM

(71) Applicant: Samsung Electronics Co., Ltd., Gyeonggi-do (KR)

(72) Inventor: Deepanshu GAUTAM, Bangalore (IN)

(21) Appl. No.: 18/745,341

(22) Filed: Jun. 17, 2024

(30) Foreign Application Priority Data
Jun. 15, 2023 (IN) 202341040897
May 24, 2024 (IN) 202341040897

(51) Int. Cl. H04W 8/20; H04W 4/12; H04W 8/18

(52) U.S. Cl. CPC H04W 8/20; H04W 4/12; H04W 8/183

(57) ABSTRACT

Disclosed is a method performed by a mobile network service (MnS) producer entity in a wireless communication system, including receiving, from an MnS consumer entity, a first message indicating a subscription to receive a managed object instance (MOI) related notification, identifying a conflict on an intent, and transmitting, to the MnS consumer entity, a second message indicating a notification of the conflict on the intent based on an intent MOI report.

### CROSS-REFERENCE TO RELATED APPLICATION(S)

This application is based on and claims priority under 35 U.S.C. § 119 to Indian Provisional Patent Application No. 202341040897, which was filed in the Indian Patent Office on Jun. 15, 2023, and to Indian patent application No. 202341040897, which was filed in the Indian Patent Office on May 24, 2024, the entire content of each of which is incorporated herein by reference.

### BACKGROUND

### 1. Field

The disclosure relates generally to a wireless communication system, and more particularly, to a method and system for intent conflict management in a wireless communication system.

### 2. Description of Related Art

Fifth generation (5G) mobile communication technologies define broad frequency bands such that high transmission rates and new services are possible and can be implemented in sub 6 gigahertz (GHz) bands such as 3.5 GHz, and also in above 6 GHz bands referred to as millimeter wave (mmWave) bands including 28 GHz and 39 GHz. In addition, it has been considered to implement sixth generation (6G) mobile communication technologies referred to as beyond 5G systems in terahertz (THz) bands (e.g., 95 GHz to 3 THz bands) to realize transmission rates fifty times faster than 5G mobile communication technologies and ultra-low latencies one-tenth of 5G mobile communication technologies.

Over the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for NR for simplifying random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks. Thus, it is anticipated that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

An intent generally specifies the expectations including requirements, goals and constraints for a specific service or network management workflow. The intent may provide information on a particular objective and possibly some related details. An intent is typically understandable by humans and needs to be interpreted by a machine without any ambiguity. An intent focuses more on describing “What” needs to be achieved and less on “How” that outcome should be achieved, and expresses the metrics that need to be achieved and not how to achieve them. This not only relieves the burden of the consumer knowing implementation details but also gives latitude to enable the producer to explore alternative options and find optimal solutions. Intent describes the properties that enable a satisfactory outcome to be realized. The expectations expressed by an intent are agnostic to the underlying system implementation, technology and infrastructure. Area can be used as a managed object in the expectations expressed by an intent to achieve system implementation, technology and infrastructure agnostics.

In an intent-based management system as per the standard 3GPP TR 28.312 V18.2.0, the management service (MnS) consumer provides its intent to the MnS producer of a set of management services that would be consumed in a specific domain. For example, to request a radio network with a new coverage, one possible solution (non-intent based approach) is to use the set of classic MnS's to decommission a cell and instantiate the cell to a new Node B for the new coverage. The alternative solution (intent based approach) is to use a management service produced by the domain, which may be referred to as the intent-based MnS by stating the intent for the radio network for the new coverage. Based on the intent, a system can trigger actions (e.g. decommission a cell and instantiate the cell to a new Node B) to satisfy the received intent. The intent-based MnS could in principle be deployed as a replacement of the deployed classic MnS for the same network and service management purpose, where the consumer focuses on the “what” and the producer is concerned about the “how”.

The MnS consumer may create an intent containing two or more intent expectations, and each intent expectation may contain multiple expectation targets. For example, a radio network related intent may express as having targets on radio network parameters (e.g., downlink transmit power, remote electrical tilt) or on key performance indicators (KPIs) (e.g., downlink user equipment (UE) throughput target, average reference signal received power (RSRP) target, coverage area). On receiving and after analyzing the intent, the MnS producer may realize that the intent expectations or expectation targets in one intent are contradicted, such that the MnS producer may detect conflicts in the intent. Also, an intent is considered to have conflict with other intents if the requirements (including intent expectation and corresponding expectation targets) stated in one intent conflict with the requirements (including intent expectation and corresponding expectation targets) stated in another intent. The existing mechanism lacks the possibility of notifying the MnS consumer about the intent conflicts and receiving its explicit confirmation before deleting a conflicting intent.

Therefore, there is a need in the art to establish an appropriate system and method that fulfil the requirements of the aforementioned problem.

### SUMMARY

The disclosure has been made to address at least the above-mentioned problems and/or disadvantages and to provide at least the advantages described below.

Accordingly, an aspect of the disclosure is to provide a method of conflict management by which an MnS consumer can be notified of intent conflicts and can give confirmation for a conflict to be deleted.

Another aspect of the disclosure is to provide a method and apparatus by which the MnS consumer system can notify information about the intent related conflicts through the intent report generated by the MnS producer system and enables the MnS consumer to set a flag to indicate approval or rejection to a resolution action intended by the MnS producer to resolve the intent related conflicts.

Another aspect of the disclosure is to provide a method and apparatus enabling the MnS consumer to accept or reject a resolution action comprising a deletion action when the type of conflict is an intent level conflict.

Another aspect of the disclosure is to provide a method and apparatus enabling the MnS consumer to accept or reject a resolution action including a modification of an expectation or a target when the type of conflict is an expectation level conflict or target level conflict.

Another aspect of the disclosure is to provide a method and apparatus by which the MnS consumer may set the decision to accept or reject of the resolution action based on the attribute and values of the corresponding attributes indicated in the intent report.

In accordance with an aspect of the disclosure, a method performed by a mobile network service (MnS) producer entity in a wireless communication system includes receiving, from an MnS consumer entity, a first message indicating a subscription to receiving a managed object instance (MOI) related notification, identifying a conflict on an intent, and transmitting, to the MnS consumer entity, a second message indicating a notification of the conflict on the intent based on an intent MOI report.

In accordance with an aspect of the disclosure, a method performed by an MnS consumer entity in a wireless communication system includes transmitting, to an MnS producer entity, a first message indicating a subscription to receiving an MOI related notification, and receiving, from the MnS producer entity, a second message indicating a notification of a conflict on an intent based on an intent MOI report.

In accordance with another aspect of the disclosure, an MnS producer entity in a wireless communication system includes a transceiver, and a controller coupled with the transceiver and configured to receive, from an MnS consumer entity, a first message indicating a subscription to receiving a managed object instance (MOI) related notification, identify a conflict on an intent, and transmit, to the MnS consumer entity, a second message indicating a notification of the conflict on the intent based on an intent MOI report.

In accordance with another aspect of the disclosure, an MnS consumer entity in a wireless communication system includes a transceiver, and a controller coupled with the transceiver and configured to transmit, to an MnS producer entity, a first message indicating a subscription to receiving an MOI related notification, and receive, from the MnS producer entity, a second message indicating a notification of a conflict on an intent based on an intent MOI report.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a architecture for communication between a MnS producer system and a MnS consumer system, according to an embodiment;

FIG. 2A illustrates a MnS producer system, according to an embodiment;

FIG. 2B illustrates a MnS consumer system, according to an embodiment;

FIG. 2C illustrates a method of intent conflict management according to an embodiment;

FIG. 2D illustrates a hierarchy of an exemplary intent according to an embodiment;

FIG. 2E illustrates a method of intent conflict management according to an embodiment;

FIG. 3 illustrates a method of intent conflict management by MnS producer system according to an embodiment;

FIG. 4 illustrates a method of intent conflict management by MnS consumer system according to an embodiment;

FIG. 5 shows a general computer system architecture, according to an embodiment;

FIG. 6 illustrates a structure of an MnS consumer entity according to an embodiment; and

FIG. 7 illustrates a structure of an MnS producer entity according to an embodiment.

### DETAILED DESCRIPTION

The following description with reference to the accompanying drawings is provided to assist in a comprehensive understanding of embodiments of the present disclosure.

Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

The enumerated listing of items herein does not imply that any or all the items are mutually exclusive, unless expressly specified otherwise. The terms “a”, “an” and “the” indicate “one or more”, unless expressly specified otherwise.

The terminology used herein is for the purposes of describing embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to indicate serving as an example, instance, or illustration. Any embodiment or implementation of the present subject matter described herein using these words/phrases is not necessarily to be construed as preferred or advantageous over other embodiments.

Those skilled in the art will understand that embodiments herein are described and are not intended to be limiting. Any two or more of the embodiments disclosed herein may be combined in any combination. Other embodiments may be utilized and other changes may be made without departing from the spirit and scope of the subject matter presented herein.

Aspects of the disclosure as shown in the drawings may be arranged, replaced, combined, separated and designed in various different configurations, all of which are contemplated herein.

Elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. One or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. One or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The various embodiments discussed below for describing the principles of the disclosure are for illustration only and should not be interpreted as limiting the scope of the disclosure in any manner. Those skilled in the art will understand that the principles of the disclosure can be implemented in any suitably arranged wireless communication system. For example, although the following detailed description of the embodiments of the disclosure will be directed to long term evolution (LTE) and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems. For example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, and 5G or new radio (NR) systems. The technical schemes of the embodiments of the present application can be applied to future-oriented communication technologies.

Hereinafter, the same reference numerals in different drawings may be used to refer to the same elements already described.

The terms “comprises”, “comprising”, or any other variations thereof, are intended herein to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

Disclosed are a system and method for conflict management in an intent-based management system including an MnS producer system and an MnS consumer system. A conflict between the intents may occur when an intent contradicts with—other intents. As discussed in background, the existing intent-based management system lacks the capability of receiving MnS consumer's explicit approval or rejection for a resolution action intended for resolving the intent based conflict. In the present disclosure, MnS producer system detects the intent related conflict and upon detection, generates an intent report including one or more predefined attributes related to intent related conflict and values corresponding to the one or more predefined attributes. The generated intent report is transmitted to the MnS consumer system to resolve the intent related conflict. The MnS consumer system sets the decision to resolve the intent related conflict and sends the decision to the MnS producer system. Based on the decision, the MnS producer system executes a resolution action. Upon execution of the resolution action, the MnS producer system notifies execution of the resolution action to the MnS consumer system. The present disclosure enables the MnS producer to notify the MnS consumer system information about the conflicts related to the intent or expectation or target via the intent report and enables the MnS consumer to set the decision to accept the resolution action or reject of the resolution action to resolve the conflict based on the attributes and values of the corresponding attributes.

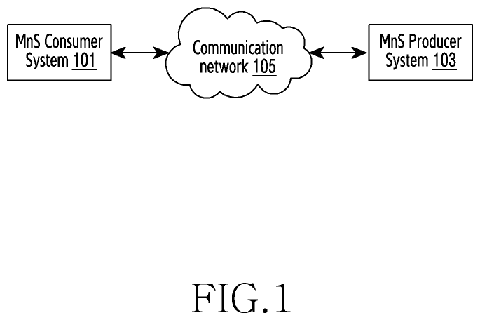

FIG. 1 illustrates an architecture for communication between an MnS producer system 103 and an MnS consumer system 101, according to an embodiment.

Referring to FIG. 1, an MnS consumer system 101 is associated with an MnS producer system 103 through a communication network 105. For example, the communication network 105 may include various types of communication networks. The communication network 105 may include local area networks, access networks, metro networks, regional networks, global networks, or the like, as well as various combinations thereof. The communication network 105 may include wired networks (e.g., digital subscriber line (DSL) networks, cable networks, optical networks, or the like), third generation (3G) or fourth-generation (4G) cellular networks, (5G) cellular networks, wireless fidelity (Wi-Fi) networks, satellite networks, and various combinations thereof. The various combinations of above-mentioned networks or other networks may be used to provide the communication network 105 for which intent-based management system is supported.

The MnS consumer system 101 may be a computing device associated with an MnS consumer. As an example, the computing device may include, without limitation, any device used by a consumer for intent related network management such as, but not limited to, smartphone, laptops, personal computers (PCs), mobile phones, wearables, Internet of things (IoT), servers, cloud instances, middleware platforms, third-party services or application programming interfaces (APIs) and the like with 5G/6G capabilities. The MnS consumer system 101 is configured to perform various tasks and functionalities within an intent-based management system.

The MnS producer system 103 may be a computing device associated with an MnS producer, such as any device used by producer for intent conflict network management such as, but not limited to servers, cloud instances, middleware platforms, third-party services or application programming interfaces (APIs) and the like with 5G/6G capabilities. The MnS producer system 103 is configured to perform various tasks and functionalities within the intent-based management system. Alternatively, the network architecture may comprise a plurality of MnS consumer systems interconnected with the central MnS producer via communication network. The aforementioned data should not be construed as a limitation of the present disclosure.

The MnS producer system 103 serves as the hub for generating or providing MnS-related services, products, or data, while the consumer systems utilize these offerings. The communication network 105 facilitates seamless interaction and exchange of information between the MnS producer system 103 and MnS consumer system 101, ensuring smooth operation and coordination within the MnS ecosystem.

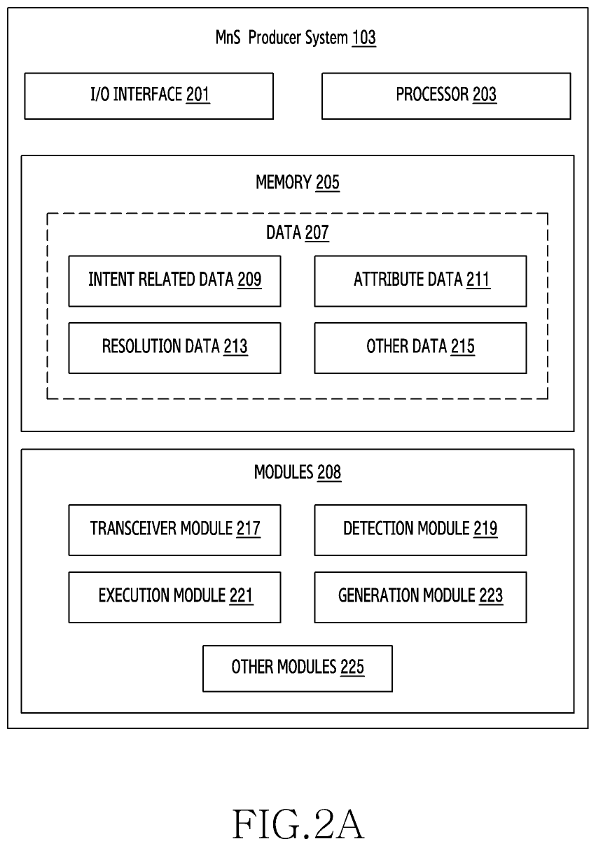

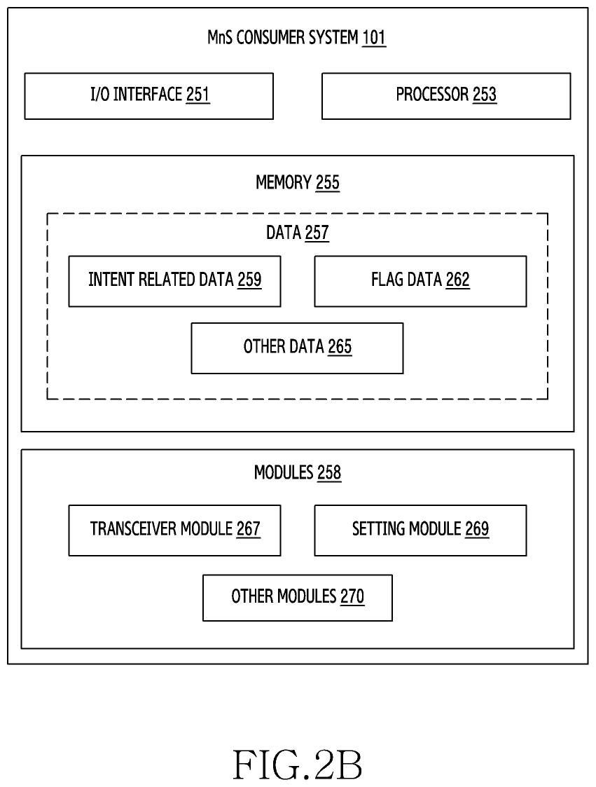

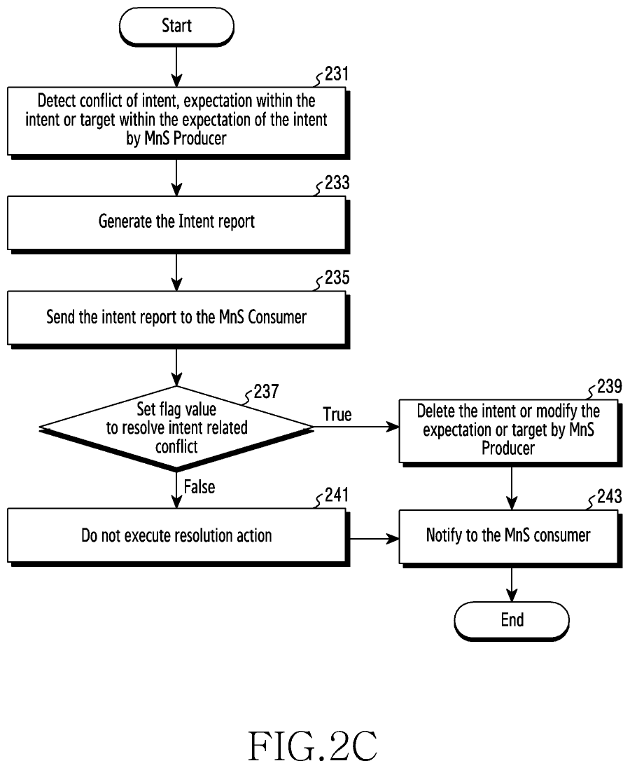

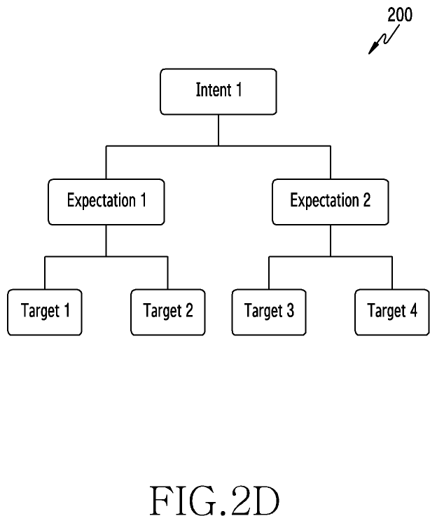

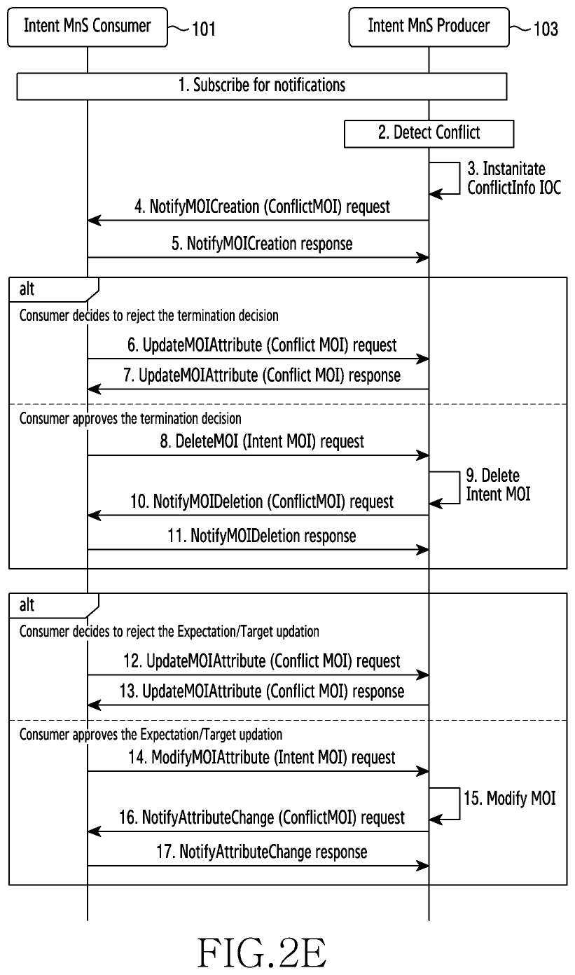

FIG. 2A illustrates an MnS producer system 103, according to an embodiment.

The MnS producer system 103 may include an input/output (I/O) interface 201, a processor 203, a memory 205 and modules 208. The memory 205 may be communicatively coupled to the processor 203. The processor 203 may be configured to perform one or more functions of the MnS producer system 103 for intent conflict management, using the data 207 and the modules 208 of the MnS producer system 103. The memory 205 may store the data 207.

The data 207 stored in the memory 205 may include, without limitation, intent related data 209, attribute data 211, resolution data 213 and other data 215. The data 207 may be stored within the memory 205 in the form of various data structures. Additionally, the data 207 may be organized using data models, such as relational or hierarchical data models. The other data 215 may include various temporary data and files generated by the one or more modules 208.

The intent related data 209 may store, without limitation, the details related to a plurality of intents, an intent related conflict between a plurality of intents, generated intent reports, intent labels or categories, intent hierarchies, historical logs, metadata.

The attribute data 211 may store, without limitation, one or more predefined attributes related to the intent related conflict. The one or more predefined attributes may include a type of the intent related conflict, the plurality of intents causing the intent related conflict, the plurality of the expectations within the intent causing the intent related conflict and the plurality of the targets within the expectation of each intent causing the intent related conflict.

The type of the intent related conflict of the attribute data 211 may include an intent level conflict, expectation level conflict and target level conflict. The intent level conflict may indicate the conflict between the plurality of intents. The expectation level conflict may indicate the conflict between the plurality of expectations of the plurality of intents. The target level conflict may indicate the conflict between the plurality of targets corresponding to at least one of the plurality of expectations of the intent.

For example, the intent report may comprise the following attributes related to the intent related conflict and indicates the support and cardinality to the corresponding attributes. Table 1 below indicates the cardinality and the support, where cardinality indicates the quantity of elements or entities linked with a specific attribute in the intent-based management system. The support may indicate parameters including mandatory (M) and conditional mandatory (CM), where M signifies that the attribute is necessary or indispensable, and CM denotes a conditionally obligatory requirement, which becomes necessary depending on particular conditions or situations.

TABLE 1

| Attribute Name | Support | Cardinality | Description |
|---|---|---|---|
| conflictType | M | 1 | Attribute “conflictType” denotes if the |
| | | | intent related conflict is at Intent level, |
| | | | expectation level or at target level. |
| conflictingIntents | CM | 1 | Attribute “conflictingIntents” denotes |
| | | | the information related with conflicting |
| | | | intents between the plurality of intents. |
| conflictingExpectations | CM | 1 | Attribute “conflictingExpectations” |
| | | | denotes the information related with |
| | | | conflicting expectations within an intent |
| | | | of the plurality of intents. |
| conflictingTargets | CM | 1 | Attribute “conflictingTargets” denotes |
| | | | the information related with conflicting |
| | | | targets within an expectation of the |
| | | | intent. |

The resolution data 213 may store flag values received from the MnS consumer system 101 and resolution actions that may be executed by the MnS producer system 103. The resolution actions may use attributes related to the deletion action or modification action. The attribute of deletion action indicates the deletion of the intent of the plurality of intents which cause intent related conflicts. The attributes of modification action may comprise the modification of the plurality of expectations of the plurality of intents and the modification of the plurality of targets corresponding to the plurality of expectations.

The resolution action is to be performed based on a flag value corresponding to a TRUE or FALSE condition. The true condition indicates acceptance of the resolution action by the MnS consumer system 101 and the false condition indicates rejection of the resolution action by the MnS consumer system 101. The default flag value is a true condition. Based on the attributes and the values of the attributes, the MnS consumer may decide to accept or reject the resolution action. The flag values may be stored as the resolution data 213.

Table 2 below shows the attributes related to the conflict between the intents.

TABLE 2

| Attribute Name | Support | Cardinality | Description |
|---|---|---|---|
| targetIntents | M | 2 . . . * | Attribute “targetIntents” denotes the |
| | | | conflicting intents between the plurality of |
| | | | intents. |
| intentToBeDeleted | M | 1 | Attribute “intentToBeDeleted” denotes the |
| | | | intent that MnS producer system has |
| | | | decided to delete to resolve the conflict. |
| allowIntentDeletion | M | 1 | Attribute “allowIntentDeletion” reflects the |
| | | | MnS consumers decision on the intent to be |
| | | | deleted. A TRUE value indicates that the |
| | | | MnS consumer agrees with the deletion. |
| | | | The FALSE value indicate that the MnS |
| | | | consumer disagrees with the deletion. |
| | | | The default value is TRUE. |

Table 3 below shows the attributes related to the conflict between the expectation within the intent.

TABLE 3

| Attribute Name | Support | Cardinality | Description |
|---|---|---|---|
| targetIntent | M | 1 | Attribute “targetIntent” denotes the |
| | | | intent. |
| targetExpectations | M | 2 . . .* | Attribute “targetIntent” denotes the |
| | | | conflicting expectations within the |
| | | | intent. |
| changedExpectation | M | 1 | Attribute “changedExpectation” |
| | | | provides the modified expectation, with |
| | | | in the intent, that MnS producer has |
| | | | decided to modify to resolve the conflict. |
| allowExpectationChange | M | 1 | Attribute “allowExpectationChange” |
| | | | reflects the MnS consumer's decision on |
| | | | the expectation to be modify. A TRUE |
| | | | value indicates that the MnS consumer |
| | | | agrees with the modification. The |
| | | | FALSE value indicates that the MnS |
| | | | consumer disagrees with the |
| | | | modification. |
| | | | The default value is TRUE. |

Table 4 below shows the attributes related to the conflict between the target of the expectation within the intent.

TABLE 4

| Attribute Name | Support | Cardinality | Description |
|---|---|---|---|
| targetIntent | M | 1 | Attribute “targetIntent” denotes the intent. |
| targetExpectations | M | 1 | Attribute “targetExpectations” denotes the |
| | | | expectation within the intent |
| targetTarget | M | 2 . . . * | Attribute “targetTarget” denotes the |
| | | | conflicting targets within the expectation. |
| changedTarget | M | 1 | Attribute “changedTarget” provides the |
| | | | modified target, within the expectation, that |
| | | | producer has decided to modify because of |
| | | | conflict. |
| allowTargetChange | M | 1 | Attribute “allowTargetChange” reflects the |
| | | | consumer's opinion on the targets to be |
| | | | changed. A TRUE value indicates that the |
| | | | consumer agrees with the change. The FALSE |
| | | | value indicates that the consumer disagrees |
| | | | with the change. |
| | | | The default value is TRUE. |

The other data 215 may store miscellaneous information which may be used to perform various miscellaneous functionalities for the intent conflict management.

The data 207 may be processed by one or more modules 208 of the MnS producer system 103. The one or more modules 208 may be communicatively coupled to the processor 203 for performing one or more functions of the MnS producer system 103 for intent conflict management. The one or more modules 208 may include, without limiting to, a transceiver module 217, detection module 219, intent report generation module 223, execution module 221 and other modules 225.

The transceiver module 217 may configured to transmit the intent report related to intent related conflict to the MnS consumer system 101. The module may further configured to the receive a response from the MnS consumer system 101. The response indicates a decision related to resolve the intent related conflict. The transceiver module 217 may also transmit or receive the intent related information, intent labels, flags, notifications, or subscription request. The transceiver module 217 may be configured for establishing and maintaining communication between MnS producer system 103 and external entities to interact within the intent-based management system. A transceiver module 217 may further configured to receive a subscription request from the MnS consumer system 101 as a pre-requisite to subscribe for the intent content management.

The detection module 219 may configured to detect the intent related conflict between a plurality of intents received from an MnS consumer system 101. Each intent of the plurality of intents may include the plurality of expectations and each of the plurality of expectations may include the plurality of targets corresponding to the plurality of expectations. It is to be understood that the detection module 219 is not limited to the above-mentioned configuration.

The intent report generation module 223 may be configured to generate an intent report upon the detection of the intent related conflict by the detection module 219 of the MnS producer system 103. The generated intent report may comprise one or more predefined attributes related to the at least one intent related conflict and values corresponding to the one or more predefined attributes. The attributes may be related to the type of intent related conflict, the plurality of intents which cause the intent related conflict, the plurality of expectations which cause the intent related conflict and the plurality of targets which cause the intent related conflict. The type of the intent related conflict may comprise the intent level conflict which indicates the conflict between the plurality of intents, an expectation level conflict which indicates the conflict between the plurality of expectations of the plurality of intents and a target level conflict which indicates the conflict between the plurality of targets corresponding to at least one of the plurality of expectations of the intent. The intent report may comprise the decision of the MnS producer system 103 to resolve the conflict related to intent. The generated intent report is transmitted to the MnS consumer system 101 to resolve the intent related conflict. The intent report may be generated based on the one or more predefined attributes and values corresponding to the attributes stored in the attribute data 211 and resolution data 213 of the memory 205.

The execution module 221 may be configured to execute a resolution action corresponding to the decision of the MnS consumer system 101, to resolve the intent related conflict. The attributes related to the resolution action and corresponding flag values of the attributes are defined as part of the resolution data 213 of the memory 205 and such attributes are used to execute the resolution action through the execution module 221. The resolution action includes a deletion modification action. The deletion action indicates the deletion of at least one intent of the plurality of intents causing intent related conflicts. The modification action indicates the modification of the at least one of a plurality of expectations of the plurality of intents or of at least one of a plurality of targets corresponding to the at least one of the plurality of expectations. The resolution action may be performed based on a flag value corresponding to a true or false condition. The true condition may indicate acceptance of the resolution action by the MnS consumer system 101 and the false condition indicates rejection of the resolution action by the MnS consumer system 101. The default flag value is a truc condition. Therefore, if the flag value indicates TRUE for deletion, then the execution module 221 may execute the deletion action such as deleting an intent of the plurality of intents. Similarly, if the flag value indicates TRUE for modification, then the execution module 221 may perform modification of the expectation or a target as indicated in the intent report.

FIG. 2B illustrates an MnS consumer system 101, according to an embodiment.

The MnS consumer system may include an I/O interface 251, a processor 253 and a memory 255. The memory 255 may be communicatively coupled to the processor 253. The processor 253 may be configured to perform one or more functions of the MnS consumer system 101 for intent conflict management, using the data 257 and the one or more modules 258 of the MnS consumer system 101. The memory 255 may store the data 257.

The data 257 stored in the memory 255 may include, without limitation, intent related data 259, flag data 262 and other data 265. The data 257 may be stored within the memory 255 in the form of various data structures. Additionally, the data 257 may be organized using data models, such as relational or hierarchical data models. The other data 265 may include various temporary data and files generated by the one or more modules 258.

The intent related data 259 may store an intent report generated by the MnS producer system 103. The intent report relates to the intent related conflict detected between a plurality of intents. The intent report may comprise predefined attributes related to intent related conflict and values corresponding to the predefined attributes. The intent report may also comprise the attributes related to the resolution actions, to resolve the conflict among the plurality of intents. The intent related data 259 may include, without limitation, intent labels, flags, intent hierarchies, conflict resolution data, one or more predefined attributes associated with the intent conflict, and values associated with the intent.

The flag data 262 may store the data related to the decision set by the MnS consumer through the MnS consumer system 101. The decision is to resolve the intent related conflict based on predefined attributes and the values corresponding to predefined attributes. The decision may comprise a flag value corresponding to a true condition or a false condition. The true condition indicates the acceptance of a resolution action to be executed for resolving the intent related conflict and the false condition indicates rejection of the resolution action. The default flag value is a true condition.

The other data 265 may store miscellaneous information which may be used to perform various miscellaneous functionalities for the intent-based network management and intent conflict management.

The data 257 may be processed by one or more modules 258 of the MnS consumer system 101. The one or more modules 258 may be communicatively coupled to the processor 253 for performing one or more functions of the MnS consumer system 101 for intent conflict management. The one or more modules 258 may include, without limitation, a transceiver module 267, a setting module 269 and other modules 270.

The transceiver module 267 may be configured to receive the intent report related to intent related conflict from MnS producer system 103. The module may be further configured to transmit a response to the MnS producer system 103. The response indicates a decision related to resolution of the intent related conflict. The transceiver module 267 may further receive the notification of execution of the resolution action corresponding to the decision of the MnS consumer system 101 from the MnS producer system 103. The transceiver module 267 may also transmit or receive the intent related information, intent labels, flags, or notifications. The transceiver module 267 may be configured for establishing and maintaining communication between the MnS consumer system 101 and external entities to interact within the intent-based management system. A transceiver module 267 may be further configured to transmit a subscription request to the MnS producer system 103 as a pre-requisite to subscribe for the intent content management.

The setting module 269 may be configured to set a flag indicating the decision of consumer related to resolution of the intent related conflicts based on the predefined attributes and the values of the predefined attributes. The setting module 269 sets the flag to either true condition or a false condition to indicate decision of the MnS consumer using the data stored in the flag data 262 of the memory 255.

The modules integral to the method are designed to execute specific functions and will be described below.

FIG. 2C illustrates a method of intent conflict management according to an embodiment.

Referring to FIG. 2C, at step 231, the detection module 219 of the MnS producer system 103 detects the intent related conflict in the plurality of the intents.

At step 233, upon the detection of the intent related conflict, the intent report generation module 223 of the MnS producer system 103 generates the intent report. The generated intent report may comprise predefined attributes related to the intent related conflict and values corresponding to predefined attributes. The attributes may be related to the type of intent related conflict, the plurality of intents which cause intent related conflict, the plurality of expectations which cause the intent related conflict and the plurality of targets which cause the intent related conflict. The type of the intent related conflict may comprise the intent level conflict which indicates the conflict between the plurality of intents, an expectation level conflict which indicates the conflict between the plurality of expectations of the plurality of intents and a target level conflict which indicates the conflict between the plurality of targets corresponding to at least one of the plurality of expectations of the intent.

At step 235, the generated intent report is transmitted to the MnS consumer system 101 to resolve the intent related conflict through the transceiver module 217 of the MnS producer system 103.

At step 237, the MnS consumer system 101 may receive the intent report through the transceiver module 267 of the MnS consumer system 101. Based on the attributes and the values corresponding to the attributes in intent report, the MnS consumer system 101 may set the decision to resolve the intent related conflict. The MnS consumer system 101 may indicate the decision for resolving the intent related conflict by a flag value corresponding to a true condition or a false condition. For example, a TRUE flag corresponds to the true condition which indicates the acceptance of the attributes related to resolution action provided by the MnS producer system 103 to MnS consumer system 101 and FALSE flag corresponds to the false condition indicates rejection of the attributes related to resolution action provided by the MnS producer system 103 to MnS consumer system 101. The decision is sent by the transceiver module 267 of the MnS consumer system 101 and the transceiver module 217 of the MnS producer system 103 receives the decision of the MnS consumer. Based on the decision sent by the MnS consumer system 101, the MnS producer system 103 may execute a resolution action through the execution module 221.

At step 239, the TRUE flag indication from the MnS consumer system 101 may be executed to delete the intent related conflict or modify the expectation or target to resolve the intent related conflict.

At step 241, the FALSE flag may indicate not to execute the resolution action.

At step 243, based on the resolution action, the transceiver module 217 of the MnS producer system 103 notifies execution of the resolution action to the MnS consumer system 101.

FIG. 2D illustrates a hierarchy 200 of the intent according to an embodiment. Referring to FIG. 2D, each intent may comprise a plurality of exceptions including plurality of targets. A single intent (Intent 1) comprises two expectations i.e., expectation 1 and expectation 2. Each expectation comprises two targets, such that expectation 1 includes target 1 and target 2, and expectation 2 includes target 3 and target 4.

Generally, an intent related conflict may indicate conflict between the plurality of intents, an expectation level conflict may indicate the conflict between the plurality of expectations of the plurality of intents, and the target level conflict may indicate the conflict between the plurality of targets corresponding at least one of the plurality of expectations of the intent.

For example, in a first scenario, assume the type of the intent related conflict indicates conflict between a plurality of the intents, i.e., intent 1 and intent 2. Assume the intent level conflict is detected by the MnS producer system 103 and denoted through the attribute “conflictType” in the intent report as shown above in Table 1. The MnS producer system 103 further indicates the attribute “conflictingIntents” which provides the information related to the conflicting intents between the plurality of intents in the intent report. The intent report comprises the attributes “targetIntents” which indicates that the conflicted intent from the plurality of the intent, and “intentToBeDeleted” which indicates to delete the conflicted intent decided by the MnS producer system 103 to resolve the intent related conflict. The intent report further comprises the resolution action attribute i.e. “allowIntentDeletion” for the MnS consumer's decision. The attribute “allowIntentDeletion” with the flag value “TRUE” is set as a default and the intent report is generated with content as shown in Table 5 and Table 6 below.

TABLE 5

| Attribute Name | Support | Cardinality | Description |
|---|---|---|---|
| conflictType | M | 1 | Intent level conflict |
| conflictingIntents | CM | 1 | TRUE |
| conflictingExpectations | CM | 1 | FALSE |
| conflictingTargets | CM | 1 | FALSE |

TABLE 6

| Attribute Name | Support | Cardinality | Description |
|---|---|---|---|
| targetIntents | M | 2 . . . * | Intent 1 and Intent 2 |
| intentToBeDeleted | M | 1 | Intent 2 |
| allowIntentDeletion | M | 1 | TRUE |

The generated intent report with the attributes and corresponding values of the attributes is sent to the MnS consumer system 101. The MnS consumer system 101 receives the intent report with all the attributes and corresponding values of the attributes. The MnS consumer system 101 may accept the decision made by the MnS producer system 103 by setting the flag value of the attribute “allowIntentDeletion” to “TRUE” indicating acceptance to delete the conflicted intent decided by the MnS producer system 103. The MnS consumer system 101 may set the flag value of “allowIntentDeletion” to “FALSE” indicating denial to delete the conflicted intent decided by the MnS producer system 103. The decision of the flag value either “TRUE” or “FALSE” of the attribute “allowIntentDeletion” is sent back to the MnS producer system 103 from the MnS consumer system 101. Based on the flag value of the attribute “allowIntentDeletion”, the MnS producer system 103 either deletes the conflicted intent or maintains the conflicted intent unchanged. Upon the execution, the MnS producer system 103 notifies the MnS consumer system 101 of the determined resolution action.

The following is a second scenario, where the intent related conflict is an expectation level conflict between the plurality of expectations and the level of the intent related conflict is detected by the MnS producer system 103 and denoted through the attribute “conflictType” as shown above in Table 1. The MnS producer system 103 indicates the attribute “conflictingExpectations” which provides the information related with conflicting expectations within the intent of the plurality of intent in the intent report. The intent report comprises the attributes “targetIntents” which indicates the conflicted intent from the plurality of the intents, “targetExpectations” which indicate the conflicted expectation within the intent, and “changedExpectation” to modify the conflicted expectation decided by the MnS producer system 103 to resolve the intent related conflict. The intent report further comprises the resolution action attribute i.e. “allowExpectationChange” for the MnS consumer's decision. The attribute “allowExpectationChange” with the flag value “TRUE” is set as a default and the intent report is generated with content as shown in Table 7 and Table 8 below.

TABLE 7

| Attribute Name | Support | Cardinality | Description |
|---|---|---|---|
| conflictType | M | 1 | Expectation level conflict |
| conflictingIntents | CM | 1 | FALSE |
| conflictingExpectations | CM | 1 | TRUE |
| conflictingTargets | CM | 1 | FALSE |

TABLE 8

| Attribute Name | Support | Cardinality | Description |
|---|---|---|---|
| targetIntent | M | 1 | Intent 1 |
| targetExpectations | M | 2 . . . * | Expectation 1 and |
| | | | Expectation 2 |
| changedExpectation | M | 1 | Modification to |
| | | | Expectation 1 |
| allowExpectationChange | M | 1 | TRUE |

The generated intent report with the attributes and corresponding values of the attributes is sent to the MnS consumer system 101. The MnS consumer system 101 receives the intent report with all the attributes and corresponding values of the attributes. The MnS consumer system 101 may accept the decision made by the MnS producer system 103 by setting the flag value of the attribute “allowExpectationChange” to TRUE for modification of the conflicted expectation within the intent. The MnS consumer system 101 may set the flag value of “allowExpectationChange” to FALSE to deny modifying the conflicted expectation decided by the MnS producer. The flag value of either TRUE or FALSE of the attribute “allowExpectationChange” is sent to the MnS producer system 103 from the MnS consumer system 101. Based on the flag value of the attribute “allowExpectationChange”, the MnS producer system 103 either modifies the conflicted expectation within the intent or maintains the conflicted expectation within the intent unchanged. Upon the execution, the MnS producer system 103 notifies the performed resolution action to the MnS consumer system 101.

The following is a third scenario, where type of the intent related conflict is a target level conflict indicating conflict between a plurality of targets i.e. target 3 and target 4. Assume the target level conflict is detected by the MnS producer system 103 and denoted through the attribute “conflictType” as shown above in Table 1. The MnS producer system 103 indicates the attribute “conflictingTargets” which provides the information related with conflicting targets within the expectations of the intent of the plurality of intents in the intent report. The intent report comprises the attributes “targetIntents” which indicates that the conflicted intent from the plurality of the intent, “targetExpectations” which indicates the conflicted expectation within the intent, “targetTarget” which indicates the conflicting targets within the expectation, and “changedTarget” to modify the conflicted target determined by the MnS producer system 103 to resolve the intent related conflict. The intent report further comprises the resolution attributes for the MnS consumer's decision. The attribute “allowTargetChange” with the flag value TRUE is set as a default and the intent report is generated with the content as shown in Table 9 and Table 10 below.

TABLE 9

| Attribute Name | Support | Cardinality | Description |
|---|---|---|---|
| conflictType | M | 1 | Target level conflict |
| conflictingIntents | CM | 1 | FALSE |
| conflictingExpectations | CM | 1 | FALSE |
| conflictingTargets | CM | 1 | TRUE |

TABLE 10

| Attribute Name | Support | Cardinality | Description |
|---|---|---|---|
| targetIntent | M | 1 | Intent 1 |
| targetExpectations | M | 1 | Expectation 2 |
| targetTarget | M | 2 . . . * | Target 3 and Target 4 |
| changedTarget | M | 1 | Modification to the Target 4 |
| allowTargetChange | M | 1 | TRUE |

The generated intent report with the attributes and corresponding values of the attributes are sent to the MnS consumer system 101. The MnS consumer system 101 receives the intent report with all the attributes and corresponding values of the attributes. The MnS consumer system 101 may accept the decision made by the MnS producer system 103 by setting the flag value of the attribute “allowTargetChange” to TRUE for modification of the conflicted target within the expectation of the intent. The MnS consumer system 101 may set the flag value of “allowTargetChange” to FALSE to reject modification of the conflicted expectation decided by the MnS producer system 103. The flag value TRUE or FALSE of the attribute “allowTargetChange” is sent to the MnS producer system 103 from the MnS consumer system 101. Based on the flag value of the attribute “allowTargetChange”, the MnS producer system 103 either modifies the conflicted expectation within the intent or maintains the conflicted expectation within the intent unchanged. Upon the execution, the MnS producer system 103 notifies the MnS consumer system 101 of the determined resolution action.

FIG. 2E illustrates a method of intent conflict management according to an embodiment.

Referring to FIG. 2E, at step 1, the MnS producer system 103 (i.e., intent MnS producer) receives a subscription request from the MnS consumer system 101 (i.e., intent MnS consumer) as a pre-requisite to subscribe for the intent content management.

At step 2, the MnS consumer system 101 detects the conflict related to the intent. Upon detection of the conflict, at step 3, the MnS producer system 103 generates the intent report, e.g., conflictedinfo information object class (IOC), which comprises predefined attributes related to the conflict and corresponding values of the attribute.

At step 4, upon generation of the intent report, the MnS producer system 103 notifies the generation of the intent report to MnS consumer system 101 through the attribute “notifyMOICreation” as defined in the relevant standard. The “notifyMOICreation” indicates a feature or capability related to notifying or signaling the creation of managed object instances (MOIs). The generated intent report may comprise predefined attributes related to the intent related conflict and values corresponding to predefined attributes. The attributes may be related to the type of intent related conflict, the plurality of intents which cause intent related conflict, the plurality of expectations which cause the intent related conflict and the plurality of targets which cause the intent related conflict. The type of the intent related conflict may comprise the intent level conflict which indicates the conflict between the plurality of intents, an expectation level conflict which indicates the conflict between the plurality of expectations of the plurality of intents and a target level conflict which indicates the conflict between the plurality of targets corresponding to at least one of the plurality of expectations of the intent.

At step 5, the MnS consumer system 101 sends the response of the intent report through the notifyMOICreation attribute as defined in the relevant standard. The response of the intent report indicates the decision related to resolution of the intent level conflict.

At step 6, when the MnS consumer system 101 decides to reject the resolution action i.e. intent to be deleted to resolve the conflict related to the intent based on the predefined attributes and values of the predefined attributes, the MnS consumer system 101 sends to the MnS producer system 103 an “updateMOIattribute” attribute request which indicates the feature or capability related to updating information associated with the attributes of the MOIs.

At step 7, upon receiving the request of the MnS consumer, the MnS producer does not execute a resolution action and notifies to the MnS consumer system 101 that the resolution action, i.e., intent to be deleted has not been executed, through the “updateMOIattribute” attribute response.

At step 8, when the MnS consumer 101 accepts the resolution action, i.e., intent to be deleted to resolve the conflict related to the intent, the MnS consumer 101 sends the decision through the attribute “deleteMOI” attribute request which indicates the feature related to deleting information associated with the attributes of MOIs.

At step 9, upon receiving the decision of the MnS consumer system 101, the MnS producer system 103 executes the resolution action by deleting the conflicted intent MOI.

At step 10, the MnS producer system 103 notifies to the MnS consumer system 101 that the resolution action is executed through the “notifyMOIdeletion” attribute which indicates the features related to notifying the information associated with the deletion of the MOIs.

At step 11, the MnS consumer system notifies to the MnS producer system 103 through the “notifyMOIdeletion” attribute.

In a similar manner, the response of the intent report indicates the decision related to resolution of the expectation level conflict or target level conflict.

At step 12, when the MnS consumer system 101 decides to reject the resolution action, i.e., expectation or target to be modified to resolve the conflict related to the intent based on the predefined attributes and values of the predefined attributes, the MnS consumer system 101 sends the “updateMOIattribute” attribute request which indicates the feature or capability related to updating information associated with the attributes of MOIs.

At step 13, upon receiving the decision of the MnS consumer, the MnS producer does not execute resolution action and notifies the MnS consumer system 101 that the resolution action i.e. expectation or target modification has not been executed through the “updateMOIattribute” attribute response.

At step 14, if the MnS consumer decides to accept the resolution action, an expectation or target to be modified to resolve the conflict related to the intent based on the predefined attributes and values of the predefined attributes is requested through the “modifyMOI” attribute which indicates the feature related to modifying information associated with the attributes of MOIs.

At step 15, upon the decision of the MnS consumer system 101, the MnS producer system 103 executes a resolution action by modifying the conflicted intent.

At step 16. MnS producer system notifies to the MnS consumer system 101 that the resolution action is executed through the “notifyattributechange” attribute which indicates the features related to notifying the information associated with the modification of MOIs.

At step 17, the MnS consumer system 101 notifies to the MnS producer system 103 through response attribute “notifyattributechange”.

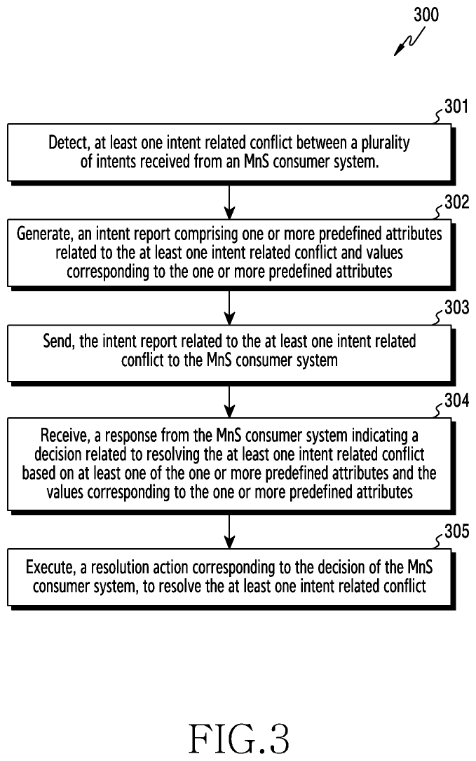

FIG. 3 illustrates a method of intent conflict management by the MnS producer system 103, according to an embodiment.

Referring to FIG. 3, the method 300 may include one or more blocks illustrating a method of an intent conflict management. The method 300 may be described in the general context of computer executable instructions including routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 301, the processor 203 of an MnS producer system detects at least one intent related conflict between a plurality of intents received from an MnS consumer system 101.

Each of the plurality of intents comprises a plurality of expectations having a plurality of targets corresponding to the plurality of expectations.

At step 302, the processor 203 generates an intent report comprising one or more predefined attributes related to the at least one intent related conflict and values corresponding to the one or more predefined attributes. The one or more predefined attributes are related to a type of the at least one intent related conflict, the plurality of intents causing the at least one intent related conflict, the plurality of expectations causing the at least one intent related conflict, and/or the plurality of targets causing the at least one intent related conflict.

The type of the at least one intent related conflict comprises an intent level conflict indicating conflict between the plurality of intents, an expectation level conflict indicating conflict between the plurality of expectations of the plurality of intents and a target level conflict indicating conflict between the plurality of targets corresponding to at least one of the plurality of expectations.

At step 303, the processor 203 sends the intent report related to the at least one intent related conflict to the MnS consumer system 101.

At step 304, the processor 203 receives a response from the MnS consumer system 101 indicating a decision related to resolving the at least one intent related conflict based on at least one of the one or more predefined attributes and the values corresponding to the one or more predefined attributes.

The resolution action may include a deletion action, which involves deletion of at least one intent of the plurality of intents causing the at least one intent related conflict. Alternatively, the resolution action may further comprise a modification action including modifying at least one of a plurality of expectations of the plurality of intents or modifying at least one of a plurality of targets corresponding to the at least one of the plurality of expectations.

The response from the MnS consumer system 101 indicates the decision related to resolving the at least one intent related conflict and includes a flag value corresponding to a true condition or a false condition. The true condition indicates acceptance of the resolution action and the false condition indicates rejection of the resolution action.

The decision of the MnS consumer system 101 to reject the resolution action is indicated to the MnS producer system 103 by changing a TRUE flag value corresponding to the resolution action to a FALSE flag value.

The decision of the MnS consumer system 101 to accept the resolution action is indicated to the MnS producer system 103 by retaining the TRUE flag value corresponding to the resolution action.

At step 305, the processor 203 executes a resolution action corresponding to the decision of the MnS consumer system 101, to resolve the at least one intent related conflict.

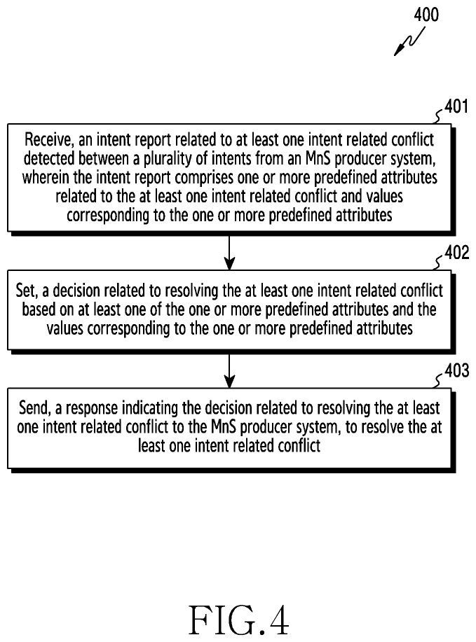

FIG. 4 illustrates a method 400 of intent conflict management by the MnS consumer system 101, according to an embodiment.

Referring to FIG. 4, at step 401, the processor 253 of the MnS consumer system receives an intent report related to at least one intent related conflict detected between a plurality of intents from an MnS producer system 103. The intent report comprises one or more predefined attributes related to the at least one intent related conflict and values corresponding to the one or more predefined attributes.

The one or more predefined attributes are related to a type of the at least one intent related conflict, the plurality of intents causing the at least one intent related conflict, the plurality of expectations causing the at least one intent related conflict, and/or the plurality of targets causing the at least one intent related conflict.

The type of the at least one intent related conflict comprises an intent level conflict indicating conflict between the plurality of intents, an expectation level conflict indicating conflict between the plurality of expectations of the plurality of intents, and a target level conflict indicating conflict between the plurality of targets corresponding to at least one of the plurality of expectations.

At step 402, the processor 253 sets a decision related to resolving the at least one intent related conflict based on at least one of the one or more predefined attributes and the values corresponding to the one or more predefined attribute.

At step 403, the processor 253 sends a response indicating the decision related to resolving the at least one intent related conflict to the MnS producer system 103, to resolve the at least one intent related conflict.

The response indicating the decision related to resolving the at least one intent related conflict comprises a flag value corresponding to a true condition or a false condition. The true condition indicates acceptance of a resolution action to be executed for resolving the at least one intent related conflict and the false condition indicates rejection of the resolution action.

The decision of the MnS consumer system 101 to reject the resolution action is indicated to the MnS producer system 103 by changing the TRUE flag value corresponding to the resolution action to a FALSE flag value.

The decision of the MnS consumer system 101 to accept the resolution action is indicated to the MnS producer system 103 by retaining the TRUE flag value corresponding to the resolution action.

The MnS consumer system 101 receives a notification of execution of the resolution action corresponding to the decision of the MnS consumer system 101 from the MnS producer system 103.

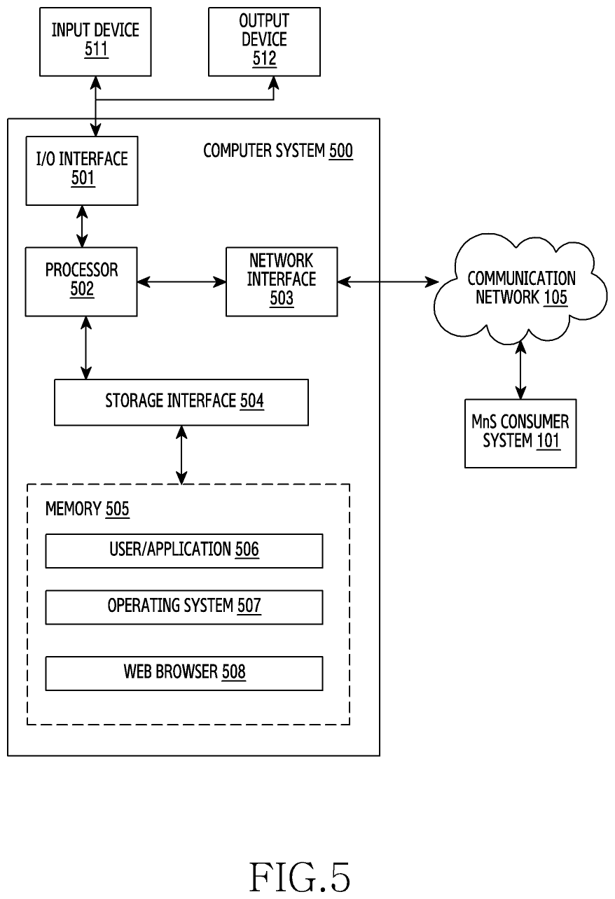

FIG. 5 illustrates a computer system 500 according to an embodiment. The computer system 500 may be an MnS producer system 103 illustrated in FIG. 1. Alternatively, the computer system 500 may be an MnS consumer system 101 and communicate with the MnS producer system 103. The computer system 500 may include a central processing unit (“CPU” or “processor” or “memory controller”) 502. The processor 502 may comprise at least one data processor for executing program components for executing user- or system-generated business processes. A user may include a network manager, an application developer, a programmer, an organization, or any system/sub-system being operated parallel to the computer system 500. The processor 502 may include specialized processing units such as integrated system (bus) controllers, memory controllers/memory management control units, floating point units, graphics processing units, digital signal processing units, etc.

The processor 502 may be disposed in communication with one or more I/O devices (511 and 512) via an I/O interface 501. The I/O interface 501 may employ communication protocols/methods such as, without limitation, audio, analog, digital, stereo, institute of electrical and electronics engineers (IEEE)®-1394, serial bus, universal serial bus (USB), infrared, PS/2, Bayonet Neill-Concelman (BNC), coaxial, component, composite, digital visual interface (DVI), high-definition multimedia interface (HDMI), radio frequency (RF) antennas, S-Video, video graphics array (VGA), IEEE® 802.n/b/g/n/x, Bluetooth™, cellular (e.g., code-division multiple access (CDMA), high-speed packet access (HSPA+), global system for mobile communications (GSM), LTE or the like), etc. Using the I/O interface 501, the computer system 500 may communicate with one or more I/O devices 511 and 512.

The processor 502 may be disposed in communication with a network 509 via a network interface 503. The network interface 503 may communicate with the network 509. The network interface 503 may employ connection protocols including, without limitation, direct connect, Ethernet (e.g., twisted pair 10/100/1000 Base T), transmission control protocol/Internet protocol (TCP/IP), token ring, IEEE® 802.11a/b/g/n/x, etc.

The preferred network 509 may be implemented as one of the several types of networks, such as intranet or local area network (LAN) and such within the organization. The preferred network 509 may either be a dedicated network or a shared network, which represents an association of several types of networks that use a variety of protocols, for example, hypertext transfer protocol (HTTP), TCP/IP, wireless application protocol (WAP) etc., to communicate with each other. The network 509 may include a variety of network devices, including routers, bridges, servers, computing devices, storage devices, etc. Using the network interface 503 and the network 509, the computer system 500 may communicate with other MnS consumers and/or MnS producers.

The processor 502 may be disposed in communication with a memory 505 via a storage interface 504. The storage interface 504 may connect to memory 505 including, without limitation, memory drives, removable disc drives, etc., employing connection protocols such as serial advanced technology attachment (SATA), integrated drive electronics (IDE), IEEE-1394, USB, fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 505 may store a collection of program or database components, including, without limitation, user/application interface 506, an operating system 507, a web browser 508, and the like. The computer system 500 may store user/application data 506, such as the data, variables, records, etc. as described in this invention. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 506 may facilitate display, execution, interaction, manipulation, or operation of program components through textual or graphical facilities. The user interface 506 may provide computer interaction interface elements on a display system operatively connected to the computer system 500, such as cursors, icons, check boxes, menus, scrollers, windows, widgets, and the like. Graphical user interfaces (GUIs) may be employed, including, without limitation, APPLE® MACINTOSH® operating systems' Aqua®, IBM® OS/2®, MICROSOFT® WINDOWS® (e.g., Acro, Metro, etc.), web interface libraries (e.g., ActiveX®, JAVA®, JAVASCRIPT®, AJAX, HTML, ADOBE® FLASH®, etc.), or the like.

The web browser 508 may be a hypertext viewing application. Secure web browsing may be provided using secure hypertext transport protocol (HTTPS), secure sockets layer (SSL), transport layer security (TLS), and the like. The web browsers 508 may utilize facilities such as AJAX, DHTML, ADOBE® FLASH®, JAVASCRIPT®, JAVA®, application programming interfaces (APIs), and the like. The computer system 500 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet message access protocol (IMAP), Messaging API (MAPI), MICROSOFT® exchange, Post Office Protocol (POP), simple mail transfer protocol (SMTP), or the like. The computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In light of the technical advancements provided by the disclosed method, the claimed steps, as discussed above, are not routine, conventional, or not well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Table 11 refers to the Reference Numerals used in this disclosure.

TABLE 11

| Reference | |
|---|---|
| Number | Description |
| 101 | MnS Consumer System |
| 103 | MnS Producer System |
| 105 | Communication network |
| 201 | Input/Output (I/O) Interface of MnS Producer |
| | System |
| 203 | Processor of MnS Producer System |
| 205 | Memory of MnS Producer System |
| 207 | Data of MnS Producer System |
| 208 | Modules of MnS Producer System |
| 209 | Intent related data |
| 211 | Attribute data |
| 213 | Resolution data |
| 215 | Other data |
| 217 | Transceiver module |
| 219 | Detection module |
| 221 | Execution module |
| 223 | Generation module |
| 225 | Other modules |
| 251 | Input/Output (I/O) Interface of MnS Consumer |
| | System |
| 253 | Processor of MnS Consumer System |
| 255 | Memory of MnS Consumer System |
| 257 | Data of MnS Consumer System |
| 258 | Modules of MnS Consumer System |
| 259 | Intent related data |
| 262 | Flag data |
| 265 | Other data |
| 267 | Transceiver module |
| 269 | Setting module |
| 270 | Other modules |
| 500 | Computer System |
| 501 | Input/Output (I/O) Interface |
| 502 | Processor |
| 503 | Network Interface |
| 504 | Storage device |
| 505 | Memory |
| 506 | User Interface |
| 507 | Operating System |
| 508 | Web Browser |
| 509 | Communication Network |
| 511 | Input Device |
| 512 | Output Device |

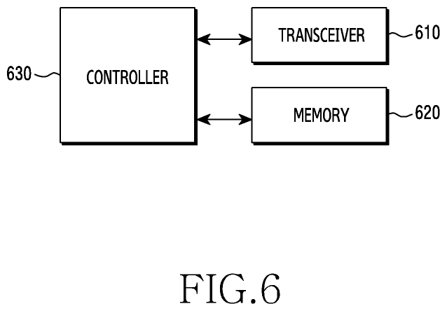

FIG. 6 illustrates a block diagram of an MnS consumer entity, according to an embodiment.

Referring to FIG. 6, an MnS consumer entity may include a transceiver 610, a memory 620, and a processor (or a controller) 630 which may operate according to a communication method of the MnS consumer entity described above. However, the components of the MnS consumer entity are not limited thereto. The MnS consumer entity may include more or fewer components than those described in FIG. 6. In addition, the processor (or controller) 630, the transceiver 610, and the memory 620 may be implemented as a single chip. Also, the processor (or controller) 630 may include at least one processor.

The transceiver 610 collectively refers to an MnS consumer entity station receiver and an MnS consumer entity transmitter and may transmit/receive a signal to/from an MnS producer entity over the network. The signal transmitted or received to or from the MnS consumer entity may include control information and data. The transceiver 610 may include an RF transmitter for up-converting and amplifying a frequency of a transmitted signal, and an RF receiver for amplifying low-noise and down-converting a frequency of a received signal. However, this is only an example of the transceiver 610 and components of the transceiver 610 are not limited to the RF transmitter and the RF receiver.

The transceiver 610 may receive and output, to the processor (or controller) 630, a signal through a wireless channel, and transmit a signal output from the processor (or controller) 630 through the wireless channel.

The memory 620 may store a program and data required for operations of the MnS consumer entity and control information or data included in a signal obtained by the MnS consumer entity. The memory 620 may be a storage medium, such as read-only memory (ROM), random access memory (RAM), a hard disk, a CD-ROM, and a DVD, or a combination of storage media.

The processor (or controller) 630 may control a series of processes such that the MnS consumer entity operates as described above. The processor (or controller) 630 may receive a data signal and/or a control signal, and the processor (or controller) 630 may determine a result of receiving the signal transmitted by the MnS producer entity and/or the other MnS consumer entity.

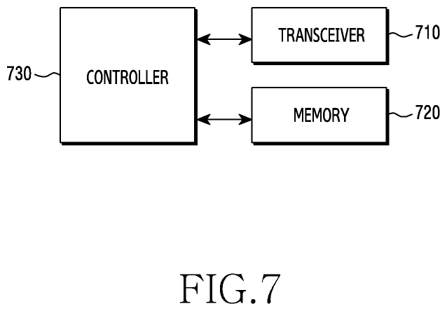

FIG. 7 illustrates a block diagram of an MnS producer entity, according to an embodiment.

Referring to FIG. 7, the MnS producer entity may include a transceiver 710, a memory 720, and a processor (or, a controller) 730 which may operate according to a communication method of the MnS producer entity described above. However, the components of the MnS producer entity are not limited thereto. The MnS producer entity may include more or fewer components than those described in FIG. 7. In addition, the processor (or controller) 730, the transceiver 710, and the memory 720 may be implemented as a single chip. The processor (or controller) 730 may include at least one processor.

The transceiver 710 collectively refers to an MnS producer entity receiver and an MnS producer entity transmitter and may transmit/receive a signal to/from an MnS consumer entity over the network. The signal transmitted or received to or from the MnS producer entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

The transceiver 710 may receive and output, to the processor (or controller) 730, a signal through a wireless channel, and transmit a signal output from the processor (or controller) 730 through the wireless channel.

The memory 720 may store a program and data required for operations of the MnS producer entity. The memory 720 may store control information or data included in a signal obtained by the MnS producer entity. The memory 720 may be a storage medium, such as ROM, RAM, a hard disk, a CD-ROM, and a DVD, or a combination of storage media.

The processor (or controller) 730 may control a series of processes such that the MnS producer entity operates as described above. The processor (or controller) 730 may receive a data signal and/or a control signal, and the processor (or controller) 730 may determine a result of receiving the signal transmitted by the MnS consumer entity and/or the core network function.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure. Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks and may be physically combined into more complex blocks without departing from the scope of the disclosure.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of the disclosure.

The various illustrative logic blocks, modules, and circuits described in this application may be implemented or performed by a general purpose processor, a digital signal processor (DSP), an application specific integrated circuit (ASIC), a field programmable gate array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, electrically erasable programmable read-only memory (EEPROM), EPROM, register, hard disk, removable disk, or any other form of storage medium known in the art. A storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

The embodiments disclosed herein can be implemented through at least one software program running on at least one hardware device and performing network management functions to control the network elements. The elements include blocks which can be at least one of a hardware device, or a combination of hardware device and software module.

The scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include an ASIC, or a combination of hardware and software, e.g., an ASIC and an FPGA, or at least one microprocessor and at least one memory with software modules located therein. The embodiments described herein could be implemented partly in hardware and partly in software. Alternatively, the invention may be implemented on different hardware devices, e.g., using a plurality of CPUs.

The above description is only an exemplary implementation of the present disclosure and is not intended to limit the scope of protection of the present disclosure.

As described above, a method of an intent conflict management includes detecting, by an MnS producer system, at least one intent related conflict between a plurality of intents received from an MnS consumer system, generating, by the MnS producer system, an intent report comprising one or more predefined attributes related to the at least one intent related conflict and values corresponding to the one or more predefined attributes, sending, by the MnS producer system, the intent report related to the at least one intent related conflict to the MnS consumer system, receiving, by the MnS producer system, a response from the MnS consumer system indicating a decision related to resolving the at least one intent related conflict based on at least one of the one or more predefined attributes and the values corresponding to the one or more predefined attributes, and executing, by the MnS producer system, a resolution action corresponding to the decision of the MnS consumer system, to resolve the at least one intent related conflict.

The one or more predefined attributes are related to a type of the at least one intent related conflict, the plurality of intents causing the at least one intent related conflict, the plurality of expectations causing the at least one intent related conflict, the plurality of targets causing the at least one intent related conflict.

The type of the at least one intent related conflict comprises an intent level conflict indicating conflict between the plurality of intents, an expectation level conflict indicating conflict between the plurality of expectations of the plurality of intents and a target level conflict indicating conflict between the plurality of targets corresponding to at least one of the plurality of expectations.

The resolution action comprises a deletion action, wherein the deletion action comprises deletion of at least one intent of the plurality of intents causing the at least one intent related conflict.

The resolution action comprises a modification action, wherein the modification action comprises at least one of modifying at least one of a plurality of expectations of the plurality of intents and modifying at least one of a plurality of targets corresponding to the at least one of the plurality of expectations.

The response from the MnS consumer system indicating the decision related to resolving the at least one intent related conflict comprises a flag value corresponding to a true condition or a false condition, wherein the true condition indicates acceptance of the resolution action and the false condition indicates rejection of the resolution action.

The decision of the MnS consumer system to reject the resolution action is indicated to the MnS producer system by changing a TRUE flag value corresponding to the resolution action with a FALSE flag value.

The decision of the MnS consumer system to accept the resolution action is indicated to the MnS producer system by retaining a TRUE flag value corresponding to the resolution action.

The method further comprises receiving, by the MnS producer system, a subscription request from the MnS consumer system as a pre-requisite to subscribe for the intent content management.

According to an embodiment of the disclosure, the method further comprises notifying, by the MnS producer system, the execution of the resolution action to the MnS consumer system.

As described above, a method for an intent conflict management includes receiving, by the MnS consumer system, an intent report related to at least one intent related conflict detected between a plurality of intents from an MnS producer system, wherein the intent report comprises one or more predefined attributes related to the at least one intent related conflict and values corresponding to the one or more predefined attributes, setting, by the MnS consumer system, a decision related to resolving the at least one intent related conflict based on at least one of the one or more predefined attributes and the values corresponding to the one or more predefined attributes, and sending, by the MnS consumer system, a response indicating the decision related to resolving the at least one intent related conflict to the MnS producer system, to resolve the at least one intent related conflict.

The one or more predefined attributes are related to a type of the at least one intent related conflict, the plurality of intents causing the at least one intent related conflict, the plurality of expectations causing the at least one intent related conflict, the plurality of targets causing the at least one intent related conflict.

The type of the at least one intent related conflict comprises an intent level conflict indicating conflict between the plurality of intents, an expectation level conflict indicating conflict between the plurality of expectations of the plurality of intents and a target level conflict indicating conflict between the plurality of targets corresponding to at least one of the plurality of expectations.

The response indicating the decision related to resolving the at least one intent related conflict comprises a flag value corresponding to a true condition or a false condition, wherein the true condition indicates acceptance of a resolution action to be executed for resolving the at least one intent related conflict and the false condition indicates rejection of the resolution action.

The decision of the MnS consumer system to reject the resolution action is indicated to the MnS producer system by changing a TRUE flag value corresponding to the resolution action with a FALSE flag value.

The decision of the MnS consumer system to accept the resolution action is indicated to the MnS producer system by retaining a TRUE flag value corresponding to the resolution action.

The method further comprises receiving, by the MnS consumer system, a notification of execution of the resolution action corresponding to the decision of the MnS consumer system from the MnS producer system.

As described above, an MnS producer system includes a processor, and a memory, communicatively coupled to the processor, wherein the memory stores instructions, which, on execution, causes the processor to detect at least one intent related conflict between a plurality of intents received from an MnS consumer system, generate an intent report comprising one or more predefined attributes related to the at least one intent related conflict and values corresponding to the one or more predefined attributes, send the intent report related to the at least one intent related conflict to the MnS consumer system, receive a response from the MnS consumer system indicating a decision related to resolving the at least one intent related conflict based on at least one of the one or more predefined attributes and the values corresponding to the one or more predefined attributes, and execute a resolution action corresponding to the decision of the MnS consumer system, to resolve the at least one intent related conflict.

The one or more predefined attributes are related to a type of the at least one intent related conflict, the plurality of intents causing the at least one intent related conflict, the plurality of expectations causing the at least one intent related conflict, the plurality of targets causing the at least one intent related conflict.

The type of the at least one intent related conflict comprises an intent level conflict indicates conflict between the plurality of intents, an expectation level conflict indicating conflict between the plurality of expectations of the plurality of intents and a target level conflict indicating conflict between the plurality of targets corresponding to at least one of the plurality of expectations.

The resolution action comprises a deletion action, wherein the deletion action comprises deletion of at least one intent of the plurality of intents causing the at least one intent related conflict.

The resolution action comprises a modification action, wherein the modification action comprises at least one of modify at least one of a plurality of expectations of the plurality of intents and modify at least one of a plurality of targets corresponding to the at least one of the plurality of expectations.

The response from the MnS consumer system indicates the decision related to resolve the at least one intent related conflict comprises a flag value corresponding to a true condition or a false condition, wherein the true condition indicates acceptance of the resolution action and the false condition indicates rejection of the resolution action.

The decision of the MnS consumer system to reject the resolution action is indicated to the MnS producer system by changing a TRUE flag value corresponding to the resolution action with a FALSE flag value.

The decision of the MnS consumer system to accept the resolution action is indicated to the MnS producer system by retaining a TRUE flag value corresponding to the resolution action.

The processor is further configured to receive a subscription request from the MnS consumer system as a pre-requisite to subscribe for the intent content management.

The processor is further configured to notify the execution of the resolution action to the MnS consumer system.

As described above, an MnS consumer system for an intent conflict management includes a processor, and a memory, communicatively coupled to the processor, wherein the memory stores instructions, which, on execution, causes the processor to receive an intent report related to at least one intent related conflict detected between a plurality of intents from an MnS producer system, wherein the intent report comprises one or more predefined attributes related to the at least one intent related conflict and values corresponding to the one or more predefined attributes, set a decision related to resolving the at least one intent related conflict based on at least one of the one or more predefined attributes and the values corresponding to the one or more predefined attributes, and send a response indicating the decision related to resolving the at least one intent related conflict to the MnS producer system, to resolve the at least one intent related conflict.

The one or more predefined attributes are related to a type of the at least one intent related conflict, the plurality of intents causing the at least one intent related conflict, the plurality of expectations causing the at least one intent related conflict, the plurality of targets causing the at least one intent related conflict.

The type of the at least one intent related conflict comprises an intent level conflict indicating conflict between the plurality of intents, an expectation level conflict indicating conflict between the plurality of expectations of the plurality of intents and a target level conflict indicating conflict between the plurality of targets corresponding to at least one of the plurality of expectations.

The response indicating the decision related to resolving the at least one intent related conflict comprises a flag value corresponding to a true condition or a false condition, wherein the true condition indicates acceptance of a resolution action to be executed for resolving the at least one intent related conflict and the false condition indicates rejection of the resolution action.

The decision of the MnS consumer system to reject the resolution action is indicated to the MnS producer system by changing a TRUE flag value corresponding to the resolution action with a FALSE flag value.

The decision of the MnS consumer system to accept the resolution action is indicated to the MnS producer system by retaining a TRUE flag value corresponding to the resolution action.

The processor is further configured to receive a notification of execution of the resolution action corresponding to the decision of the MnS consumer system from the MnS producer system.

As used herein, the term module may refer to an application specific integrated circuit (ASIC), an electronic circuit, a hardware processor (shared, dedicated, or group) and memory that execute one or more software or firmware programs, a combinational logic circuit, and/or other suitable components that provide the described functionality. Each of the one or more modules may be configured as stand-alone hardware computing units. The other modules may be used to perform various miscellaneous functionalities of the MnS producer system. It will be appreciated that such one or more modules may be represented as a single module or a combination of different modules.

One or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, compact disc (CD) ROMs, digital video disc (DVDs), flash drives, disks, and any other known physical storage media.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a mobile network service (MnS) producer entity in a wireless communication system, the method comprising:
receiving, from an MnS consumer entity, a first message indicating a subscription to receive a managed object instance (MOI) related notification;
identifying a conflict on an intent; and
transmitting, to the MnS consumer entity, a second message indicating a notification of the conflict on the intent based on an intent MOI report.

2. The method of claim 1, further comprising:
receiving, from the MnS consumer entity, a third message requesting a deletion of the intent based on the second message.

3. The method of claim 1, further comprising:
receiving, from the MnS consumer entity, a fourth message requesting a modification of the intent based on the second message.

4. The method of claim 1,
wherein the second message further includes attribute information on the intent, the attribute information including information on at least one of a conflict type, a conflicting intent, a conflicting expectation, or a conflicting target.

5. The method of claim 4,
wherein the attribute information further includes information indicating that the intent is to be deleted.

6. A method performed by a mobile network service (MnS) consumer entity in a wireless communication system, the method comprising:
transmitting, to an MnS producer entity, a first message indicating a subscription to receive a managed object instance (MOI) related notification; and
receiving, from the MnS producer entity, a second message indicating a notification of a conflict on an intent based on an intent MOI report.

7. The method of claim 6, further comprising:
transmitting, to the MnS producer entity, a third message requesting a deletion of the intent based on the second message.

8. The method of claim 6, further comprising:
transmitting, to the MnS producer entity, a fourth message requesting a modification of the intent based on the second message.

9. The method of claim 6,
wherein the second message further includes attribute information on the intent, the attribute information including information on at least one of a conflict type, a conflicting intent, a conflicting expectation, or a conflicting target.

10. The method of claim 9,
wherein the attribute information further includes information indicating that the intent is to be deleted.

11. A mobile network service (MnS) producer entity in a wireless communication system, the MnS producer entity comprising:
a transceiver; and
a controller coupled with the transceiver and configured to:
receive, from an MnS consumer entity, a first message indicating a subscription to receive a managed object instance (MOI) related notification,
identify a conflict on an intent, and
transmit, to the MnS consumer entity, a second message indicating a notification of the conflict on the intent based on an intent MOI report.

12. The MnS producer entity of claim 11, wherein the controller is further configured to:
receive, from the MnS consumer entity, a third message requesting a deletion of the intent based on the second message.

13. The MnS producer entity of claim 11, wherein the controller is further configured to:
receive, from the MnS consumer entity, a fourth message requesting a modification of the intent based on the second message.

14. The MnS producer entity of claim 11,
wherein the second message further includes attribute information on the intent, the attribute information including information on at least one of a conflict type, a conflicting intent, a conflicting expectation, or a conflicting target.

15. The MnS producer entity of claim 14,
wherein the attribute information further includes information indicating that the intent is to be deleted.

16. A mobile network service (MnS) consumer entity in a wireless communication system, the MnS consumer entity comprising:
a transceiver; and
a controller coupled with the transceiver and configured to:
transmit, to an MnS producer entity, a first message indicating a subscription to receive a managed object instance (MOI) related notification, and
receive, from the MnS producer entity, a second message indicating a notification of a conflict on an intent based on an intent MOI report.

17. The MnS consumer entity of claim 16, wherein the controller is further configured to:
transmit, to the MnS producer entity, a third message requesting a deletion of the intent based on the second message.

18. The MnS consumer entity of claim 16, wherein the controller is further configured to:
transmitting, to the MnS producer entity, a fourth message requesting a modification of the intent based on the second message.

19. The MnS consumer entity of claim 16,
wherein the second message further includes attribute information on the intent, the attribute information including information on at least one of a conflict type, a conflicting intent, a conflicting expectation, or a conflicting target.

20. The MnS consumer entity of claim 19,
wherein the attribute information further includes information indicating that the intent is to be deleted.
